(19) United States
(12) Patent Application Publication
(10) Pub. No.: US 2009/0315798 A1
(43) Pub. Date: Dec. 24, 2009

(54) ANTENNA FOR RADIO FREQUENCY RECEPTION

(75) Inventors: Hyun Kil Nam, Seoul (KR); Sung Eun Cho, Suwon (KR); Ha Ryong Hong, Hwaseong (KR); Chan Gwang An, Suwon (KR); Jae Suk Sung, Yongin (KR); Dae Seong Jeon, Suwon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Samsung Electro-Machanics Co., Ltd., Suwon (KR)

(21) Appl. No.: 12/255,260

(22) Filed: Oct. 21, 2008

(30) Foreign Application Priority Data
Jun. 24, 2008 (KR) 10-2008-0059719

(51) Int. Cl. H01Q 1/38; H01Q 1/46; H01Q 1/00

(52) U.S. Cl. 343/787; 343/700 MS; 343/895

(57) ABSTRACT

An antenna for radio frequency (RF) reception includes a substrate, a first radiator disposed in one region of the substrate and receiving a signal of a first frequency band, and a second radiator disposed in another region of the substrate and receiving a signal of a second frequency band.

### CROSS-REFERENCE TO RELATED APPLICATIONS

This application claims the priority of Korean Patent Application No. 2008-59719 filed on Jun. 24, 2008, in the Korean Intellectual Property Office, the disclosure of which is incorporated herein by reference.

### BACKGROUND OF THE INVENTION

1. Field of the Invention

The present invention relates to an antenna for radio frequency (RF) reception, and more particularly, to an antenna for RF reception, which can improve reception efficiency and contribute to miniaturization of a mobile communication terminal by forming a radiator for amplitude modulation (AM) reception and a radiator for frequency modulation (FM) reception at one substrate.

2. Description of the Related Art

The mobile communication technology has created a new communication culture based on the rapid development of information communication technologies and economic growth. Specifically, the mobile communication technology is providing various services for everyday life regardless of location, such as personal mobile communication and information services, and personal financial services.

The development of the mobile communication technology has increased the number of subscribers of mobile communication systems. Therefore, a new mobile communication method and the use of multiple frequency bands have become necessary to cover demands of the increasing subscribers. To this end, wideband and multiband terminals that can selectively use multiple frequency bands are being required.

Particularly, an antenna for receiving broadcasting waves needs to have a physical length which is inversely proportional to a frequency. Hence, the antenna, in many cases, is provided in the form of an external antenna to a mobile communication terminal. However, the external antenna degrades convenience of users and the degree of design freedom.

If an antenna is manufactured by forming a metal radiator at a molding, it has a limitation of a narrow bandwidth.

### SUMMARY OF THE INVENTION

An aspect of the present invention provides an antenna for radio frequency (RF) reception, which can improve reception efficiency thereof while contributing to miniaturization of a mobile communication terminal.

According to an aspect of the present invention, there is provided an antenna for radio frequency (RF) reception, including: a substrate; a first radiator disposed in one region of the substrate and receiving a signal of a first frequency band; and a second radiator disposed in another region of the substrate and receiving a signal of a second frequency band.

The substrate may be a flexible printed circuit board (FPCB).

The substrate may be a carrier film. The antenna may further include a case for a mobile communication terminal, the case being formed integrally with the carrier film.

The first radiator may have a spiral shape. The first radiator may have one end connected to a feeding unit and the other end connected to a ground.

The second radiator may have a meander line shape. The second radiator may have one end connected to a feeding unit and the other end which is open.

According to another aspect of the present invention, there is provided an antenna for radio frequency (RF) reception, including: a substrate; a first radiator disposed in one region of the substrate and receiving a signal of a first frequency band; a second radiator disposed in another region of the substrate and receiving a signal of a second frequency band; and a reception enhancement sheet contacting at least one of the first radiator and the second radiator.

The reception enhancement sheet may be a magnetic or dielectric sheet.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an exploded perspective view of an antenna for radio frequency (RF) reception according to an exemplary embodiment of the present invention;

FIG. 2 is a perspective view of an antenna for RF reception according to another exemplary embodiment of the present invention;

FIG. 3 is an exploded perspective view of an antenna for RF reception according to still another exemplary embodiment of the present invention; and

FIG. 4 is a perspective view of an antenna for RF reception according to yet another exemplary embodiment of the present invention.

### DETAILED DESCRIPTION OF THE PREFERRED EMBODIMENT

Exemplary embodiments of the present invention will now be described in detail with reference to the accompanying drawings.

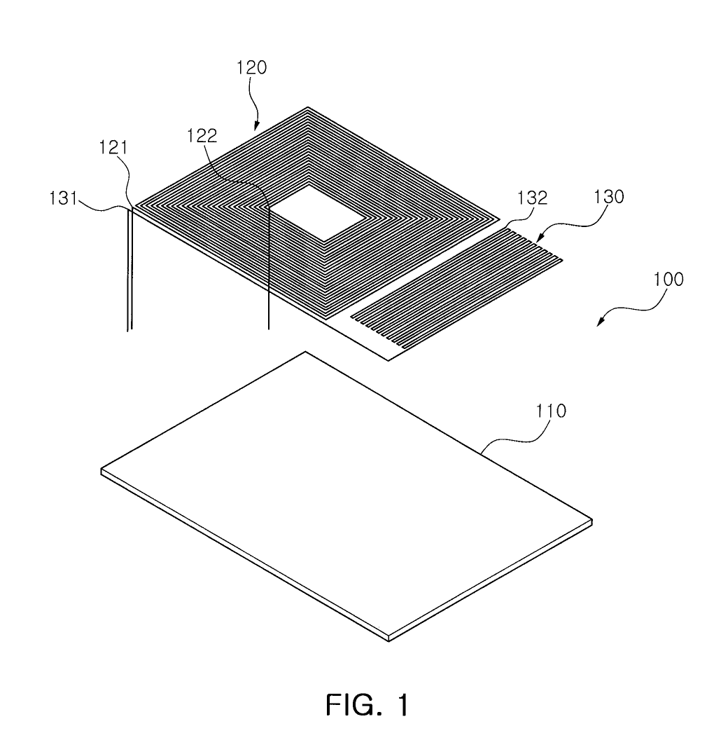

FIG. 1 is an exploded perspective view of an antenna for radio frequency (RF) reception according to an exemplary embodiment of the present invention.

Referring to FIG. 1, an antenna 100 for RF reception according to this embodiment may include a substrate 110, a first radiator 120 and a second radiator 130.

The substrate 110 may be a flexible printed circuit board (FPCB). The FPCB is attachable to various types of substrates because of its thinness and flexibility. In this embodiment, the FPCB may be attached to a case of a mobile communication terminal.

A process for forming the first radiator 120 and the second radiator 130 on the FPCB may be variously implemented. That is, the first radiator 120 and the second radiator 130 may be formed by using a printing process using conductive ink or a lithography process. Alternatively, the first and second radiators 120 and 130 may be formed by bonding a conductive metal layer onto the FPCB.

According to this embodiment, an antenna for amplitude modulation (AM) reception and an antenna for frequency modulation (FM) reception are provided at one substrate, thereby contributing to the miniaturization of a mobile communication terminal to which the antenna is mounted.

The first radiator 120 may be a radiator for AM frequency reception.

The first radiator 120 may have one end 121 connected to a feeding unit, and the other end 122 connected to the ground. The first radiator 120 may have a predetermined electrical length for the reception of an AM frequency signal.

According to this embodiment, the first radiator 120 may have a spiral shape. The first radiator 120 must have a predetermined length to have an electrical length allowing reception of the AM frequency signal. Hence, the first radiator 120 may be spirally implemented so as to have a predetermined physical length within a limited substrate. Although the first radiator 120 has a spiral shape of repeated rectangular turns in this embodiment, the present invention is not limited thereto, and the first radiator 120 may have a spiral shape of various turns such as circular turns or triangular turns.

The second radiator 130 may be a radiator for FM frequency reception.

The second radiator 130 may be disposed in a region of the substrate 110 in which the first radiator 120 is not disposed. According to this embodiment, the first radiator 120 and the second radiator 130 may be disposed on the same plane of the substrate 110. The first radiator 120 and the second radiator 130, however, may be disposed on opposing faces of the substrate 110, respectively. The second radiator 130 may have one end 131 connected to a feeding unit and the other 132 which is open.

According to this embodiment, the radiator 130 may have a meander line shape. The second radiator 130 having the meander line shape may have an electrical length sufficient for the FM frequency reception.

According to this embodiment, the first radiator 120 is for an AM frequency, and the second radiator 130 is for an FM frequency. However, a radiator for the AM frequency reception may have a meander line shape, and a radiator for the FM frequency reception may have a spiral shape.

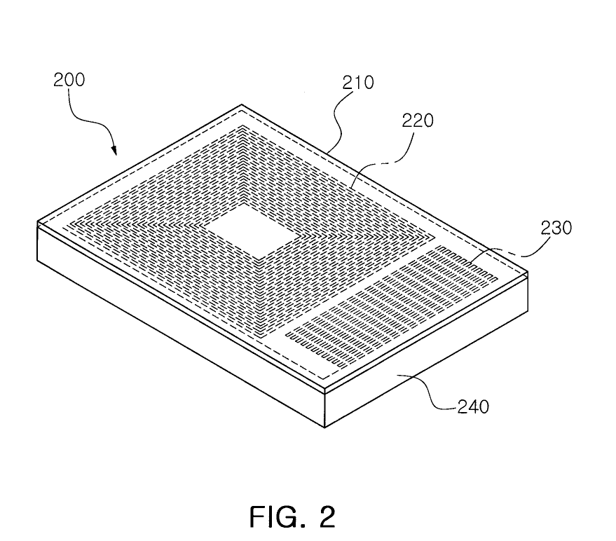

FIG. 2 is a perspective view of an antenna for RF reception according to another exemplary embodiment of the present invention.

Referring to FIG. 2, an antenna 200 for RF reception, according to this embodiment, may include a substrate 210, a first radiator 220, a second radiator 230 and a mobile communication terminal case 240.

The substrate 210 may be a carrier film.

According to this embodiment, the carrier film may be formed integrally with a case 240 of a mobile communication terminal. An in-molding process may be used in order to integrally form the carrier film and the case 240 of the mobile communication terminal.

A process for forming the first radiator 220 and the second radiator 230 on the carrier film may be variously implemented. That is, the first and second radiators 220 and 230 may be formed by a printing method using conductive ink or a lithography process. Alternatively, the first and second radiators 220 may be formed by bonding a conductive metal layer on the carrier film.

The first radiator 220 may be a radiator for AM frequency reception.

The first radiator 220 may have one end connected to a feeding unit and the other connected to the ground. The first radiator 220 may have a predetermined electrical length for the reception of an AM frequency signal.

According to this embodiment, the first radiator 220 may have a spiral shape. The first radiator 220 must have a predetermined length so as to have an electrical length allowing the reception of the AM frequency signal. Hence, the first radiator 220 may have a spiral shape to have a predetermined electrical length within a limited substrate. According to this embodiment, the first radiator 220 has a spiral shape of repeated rectangular turns. However, the present invention is not limited thereto, and the spiral shape may have a spiral shape of various turns such as circular turns or triangular turns.

The second radiator 230 may be a radiator for FM frequency reception.

The second radiator 230 may be disposed in a region of the carrier film in which the first radiator 220 is not disposed. According to this embodiment, the first radiator 220 and the second radiator 230 may be disposed on the same plane of substrate 210. The first radiator 220 and the second radiator 230, however, may be formed on opposing faces of the substrate 210, respectively. The second radiator 130 may have one end connected to a feeding unit and the other end which is open.

According to this embodiment, the second radiator 230 may have a meander line shape. The second radiator 230 of the meander line shape may have an electrical length for the FM frequency reception.

The case 240 of the mobile communication terminal may be provided using an in-molding process. That is, the carrier film including the first radiator 220 and the second radiator 230 is placed within a mold for molding the case 240 of the mobile communication terminal, and then a molding material is injected therein for molding. As a result, the case 240 of the mobile communication terminal is formed integrally with the carrier film. Thus, the first radiator 220 and the second radiator 230 may be placed between the case 240 and the carrier film.

If the antenna 200 is formed at the case 240 of the mobile communication terminal by using the in-molding process as described above, a separate space for mounting an antenna is not needed, thereby contributing to the miniaturization of the mobile communication terminal.

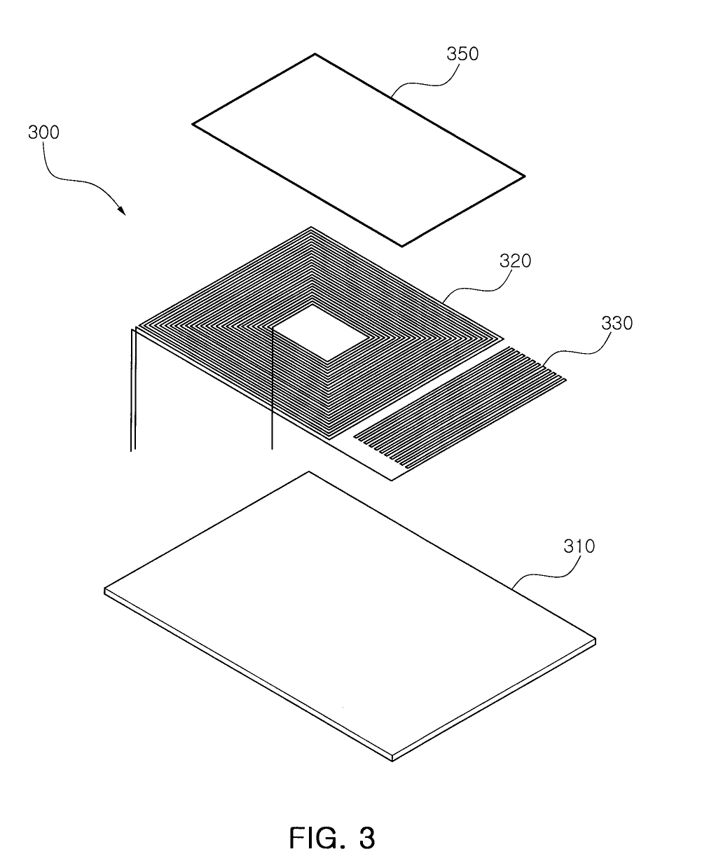

FIG. 3 is an exploded perspective view of an antenna for RF reception according to still another exemplary embodiment of the present invention.

Referring to FIG. 3, an antenna 300 for receiving an RF frequency according to this embodiment includes a substrate 310, a first radiator 320, a second radiator 330, and a reception enhancement sheet 350.

The substrate 310 may be an FPCB. The FPCB is attachable to various types of substrates because of its thinness and flexibility. In this embodiment, the substrate 310, which is the FPCB, may be attached to a case of a mobile communication terminal.

A process for forming the first radiator 320 and the second radiator 330 on the FPCB may be variously implemented. That is, the first radiator 320 and the second radiator 330 may be formed by a printing process using conductive ink or a lithography process. Alternatively, the first and second radiators 320 and 330 may be formed by bonding a conductive metal layer onto the FPCB.

The first radiator 320 may be a radiator for AM frequency reception.

The first radiator 320 may have one end connected to a feeding unit and the other end connected to the ground. The first radiator 320 may have a predetermined electrical length in order to receive an AM frequency signal.

According to this embodiment, the first radiator 320 may be spirally implemented. The first radiator 320 must have a predetermined length to have an electrical length for reception of the AM frequency signal. Hence, the first radiator 320 may have a spiral shape so as to have a predetermined physical length within a limited substrate. According to this embodiment, the first radiator 320 has a spiral shape of repeated rectangular turns. However, the present invention is not limited thereto, and the first radiator 320 may have a spiral shape of various turns such as circular turns or triangular turns.

The second radiator 330 may be a radiator for FM frequency reception.

The second radiator 330 may be disposed in a region of the substrate 310 in which the first radiator 320 is not formed. According to this embodiment, the first radiator 320 and the second radiator 330 may be disposed on the same plane of the substrate 310. The first radiator 320 and the second radiator 330, however, may be disposed on opposing faces of the substrate 310, respectively. The second radiator 330 may have one end connected to a feeding unit and the other end which is open.

According to this embodiment, the second radiator 330 may have a meander line shape. The second radiator 330 of the meander line shape may have an electrical length for the FM frequency reception.

The reception enhancement sheet 350 may contact the first and second radiators 320 and 330. The reception enforcement sheet 350 may be a magnetic sheet or a dielectric sheet. According to this embodiment, the reception enforcement sheet 350 may be a magnetic sheet. When the magnetic sheet contacts the first and second radiators 320 and 330, the reception efficiency of the antenna 300 for RF reception can be increased by the interaction between the magnetic sheet and the radiator.

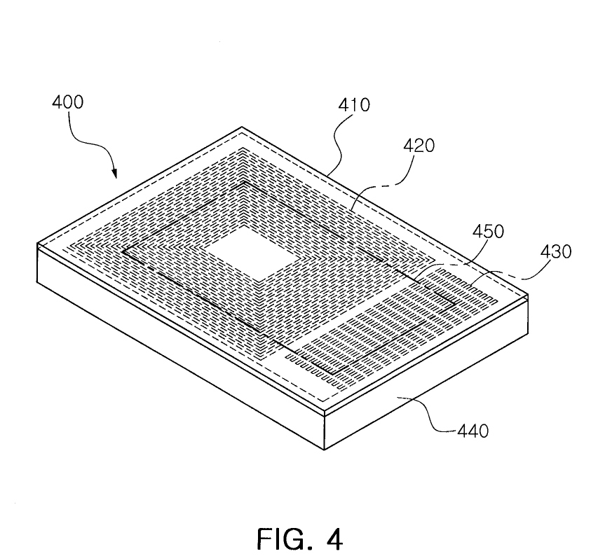

FIG. 4 is a perspective view of an antenna for RF reception according to yet another exemplary embodiment of the present invention.

Referring to FIG. 4, an antenna 400 for RF reception according to this embodiment includes a substrate 410, a first radiator 420, a second radiator 430, a reception enhancement sheet 450, and a case 440 of a mobile communication terminal.

The substrate 410 may be a carrier film.

According to this embodiment, the carrier film may be formed integrally with the case 440 of the mobile communication terminal. An in-molding process may be used to integrally form the carrier film and the case 440 of the mobile communication terminal.

A process for forming the first and second radiators 420 and 430 on the carrier film may be variously implemented. That is, the first and second radiators 420 and 430 may be formed using a printing process using conductive ink or a lithography process. Alternatively, the first and second radiators 420 and 430 may be formed by bonding a conductive metal layer on the carrier film.

The first radiator 420 may be a radiator for AM frequency reception.

The first radiator 420 may have one end connected to a feeding unit and the other end connected to the ground. The first radiator 420 may have a predetermined electrical length in order to receive an AM frequency signal.

According to this embodiment, the first radiator 420 may have a spiral shape. To obtain an electrical length allowing reception of the AM frequency signal, the first radiator 420 must have a predetermined length. Hence, the first radiator 420 may be spirally implemented to have a predetermined physical length within a limited substrate. Although the first radiator 420 has a spiral shape of repeated rectangular turns in this embodiment, the first radiator 420 may have a spiral shape of various turns such as circular turns or triangular turns.

The second radiator 430 may be a radiator for FM frequency reception.

The second radiator 430 may be disposed in a region of the carrier film in which the first radiator 420 is not formed. According to this embodiment, the first radiator 420 and the second radiator 430 may be disposed on the same plane of the substrate 410. The first radiator 420 and the second radiator 430, however, may be disposed on opposing faces of the substrate 410, respectively. The second radiator 430 may have one end connected to a feeding unit and the other end which is open.

According to this embodiment, the second radiator 430 may have a meander line shape. The second radiator 430 of the meander line shape may have an electrical length for the FM frequency reception.

The reception enhancement sheet 450 may contact the first and second radiators 420 and 430. The reception enhancement sheet 450 may be a magnetic sheet or a dielectric sheet. According to this embodiment, the reception enhancement sheet 450 may be a magnetic sheet. If the reception enhancement sheet 450, which is the magnetic sheet, contacts the first and second radiators 420 and 430, the reception efficiency of the antenna 400 for RF reception can be increased through the interaction between the magnetic sheet and the radiator.

The case 440 of the mobile communication terminal may be formed by using an in-molding process. That is, the carrier film which has one surface on which the first and second radiators 420 and 430 are formed and which the magnetic sheet is bonded to is placed within a mold for molding the case 440 of the mobile communication terminal. Thereafter, a molding material is injected therein for molding. As a result, the case 440 of the mobile communication terminal is formed integrally with the carrier film. Thus, the first radiator 420 and the second radiator 430 may be placed between the case 440 and the carrier film.

If the antenna 400 is formed at the case 440 of the mobile communication terminal using the in-molding process as described above, a separate space for mounting an antenna is not needed, thereby contributing to the miniaturization of the mobile communication terminal.

According to the present invention, an antenna for RF reception can have improved reception efficiency while contributing to miniaturization of a mobile communication terminal.

While the present invention has been shown and described in connection with the exemplary embodiments, it will be apparent to those skilled in the art that modifications and variations can be made without departing from the spirit and scope of the invention as defined by the appended claims.

What is claimed is:

1. An antenna for radio frequency (RF) reception, the antenna comprising:
a substrate;
a first radiator disposed in one region of the substrate and receiving a signal of a first frequency band; and
a second radiator disposed in another region of the substrate and receiving a signal of a second frequency band.

2. The antenna of claim 1, wherein the substrate is a flexible printed circuit board (FPCB).

3. The antenna of claim 1, wherein the substrate is a carrier film.

4. The antenna of claim 3, further comprising a case for a mobile communication terminal, the case being formed integrally with the carrier film.

5. The antenna for RF reception of claim 1, wherein the first radiator has a spiral shape.

6. The antenna of claim 1, wherein the first radiator has one end connected to a feeding unit and the other end connected to a ground.

7. The antenna of claim 1, wherein the second radiator has a meander line shape.

8. The antenna of claim 1, wherein the second radiator has one end connected to a feeding unit and the other end which is open.

9. An antenna for radio frequency (RF) reception, the antenna comprising:
a substrate;
a first radiator disposed in one region of the substrate and receiving a signal of a first frequency band;
a second radiator disposed in another region of the substrate and receiving a signal of a second frequency band; and
a reception enhancement sheet contacting at least one of the first radiator and the second radiator.

10. The antenna of claim 9, wherein the substrate is a flexible printed circuit board (FPCB).

11. The antenna of claim 9, wherein the substrate is a carrier film.

12. The antenna of claim 11, further comprising a case for a mobile communication terminal, the case being formed integrally with the carrier film by using an in-molding process.

13. The antenna of claim 9, wherein the first radiator has a spiral shape.

14. The antenna of claim 9, wherein the first radiator has one end connected to a feeding unit and the other end connected to a ground.

15. The antenna of claim 9, wherein the second radiator has a meander line shape.

16. The antenna of claim 9, wherein the second radiator has one end connected to a feeding unit and the other end which is open.

17. The antenna of claim 9, wherein the reception enhancement sheet is a magnetic sheet or a dielectric sheet.
